(19) United States
(12) Patent Application Publication
(10) Pub. No.: US 2008/0087305 A1
(43) Pub. Date: Apr. 17, 2008

(54) DUST SUPPRESSANT

(76) Inventor: Jerry Cotter, Norco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/550,298

(22) Filed: Oct. 17, 2006

(51) Int. Cl. B08B 17/02; B08B 13/00; G06Q 30/00; B08B 15/00

(52) U.S. Cl. 134/42; 134/198; 705/1

(57) ABSTRACT

A dust suppressant for suppressing dust that is otherwise lifted from an earthen surface, such as by wind, comprises a mixture of expired beverages. The expired beverage dust suppressant may be applied to any surface for which dust suppression is desired and may be applied using a water truck, for example. The expired beverage dust suppressant may also comprise additional substances that improve dust suppression.

### BACKGROUND OF THE INVENTION

1. Field of the Invention

The invention relates to systems and methods of suppressing dust and, more specifically, to systems and methods of suppressing dust using expired beverages, such as expired soft drinks and juices.

2. Description of the Related Art

Dust suppressants may be used at construction sites to reduce the amount of dust that is carried from the construction sites. For example, many municipal, state, and/or other government regulations require and/or suggest use of dust suppressants in certain construction projects. Several dust suppressant materials are currently marketed to construction companies, and others, for suppressing dust at building sites, for example. These dust suppressants include materials such as synthetic resins, asphaltic emulsions, polymer emolsions, and hygroscopic salt, for example. Thus, currently available dust suppressants comprise mixtures of organic and/or non-organic substances that are formulated by the manufacturer for suppressing dust. These substances are then combined at a fabrication facility and sold to construction companies, for example, in order to provide some reduction in the dust that is lifted from an area that is treated with the dust suppressant. However, because currently available dust suppressants are formulations of multiple substances that vary per manufacturer, each manufacturer must purchase the required substances and manage the fabrication of the dust suppressant mixture within a manufacturing facility. Thus, there is a materials and labor cost associated with fabrication of currently available dust suppressant. These costs are passed along to the consumers, such as builders, in the purchase price of the dust suppressant and these costs may be passed along to the eventual purchaser of the building structure. Accordingly, improved methods and systems of providing reduced cost dust suppressant are desired.

### SUMMARY OF THE INVENTION

In one embodiment, a method of suppressing dust at a construction site comprises providing a vehicle equipped with a liquid holding tank and one or more liquid discharge devices, filling at least a portion of the liquid holding tank with a mixture of expired soft drinks, the expired soft drinks being previously approved for human consumption, but at the time of performing the filling have passed respective expiration dates, positioning the vehicle at an application site having an earthen surface, and discharging portions of the mixture so that the mixture substantially covers a portion of the earthen surface, at least a portion of the mixture further mixing with dust on the earthen surface so as to retain the dust on the earthen surface and reduce an amount of dust that lifts from the earthen surface

In another embodiment, a dust suppressant apparatus comprises a container holding a dust suppressant comprising a mixture of expired beverages, the expired beverages selected from the group comprising soft drinks, juices, and alcoholic drinks, wherein each of the expired beverages are associated with an expiration date that is earlier than a current date; and a discharge apparatus configured to spray the mixture onto an earthen surface in order to reduce an amount of dust particles that are lifted from the earthen surface.

In another embodiment, a method of providing dust suppressant comprises receiving an order from a purchaser for dust suppressant, wherein the dust suppressant comprises at least about fifty percent expired beverages, authorizing a dust suppressant delivery vehicle to load the ordered quantity of dust suppressant at a facility that contains expired beverages, and receiving payment from the purchaser for the ordered quantity of dust suppressant.

### BRIEF DESCRIPTION OF THE DRAWINGS

FIG. 1 illustrates a water truck, or other fluid delivery truck, receiving a quantity of expired beverages.

FIG. 2 illustrates the water truck of FIG. 1 discharging the expired beverages in order to suppress dust.

FIG. 3 is a cross-sectional view of an uppermost layer of dirt that is partially covered by the discharged dust suppressant.

FIG. 4 is a flowchart illustrating an exemplary method of suppressing dust.

FIG. 5 is a flowchart illustrating an exemplary method of supplying dust suppressant to purchasers.

### DETAILED DESCRIPTION OF THE PREFERRED EMBODIMENT

Embodiments of the invention will now be described with reference to the accompanying Figures, wherein like numerals refer to like elements throughout. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

As noted above, certain states and/or municipalities have regulations that require or suggest that dust suppressant is applied to construction sites, such as any ground that is broken for construction. However, because of the cost of currently available dust suppressants, many construction sites fail to comply with this requirement. Likewise, there are many other areas where having dust suppressant covering the ground may be desirable. For example, any dirt lots that are near residential areas, or near areas where people gather, may desire to have dust suppressant applied to at least a portion of the land.

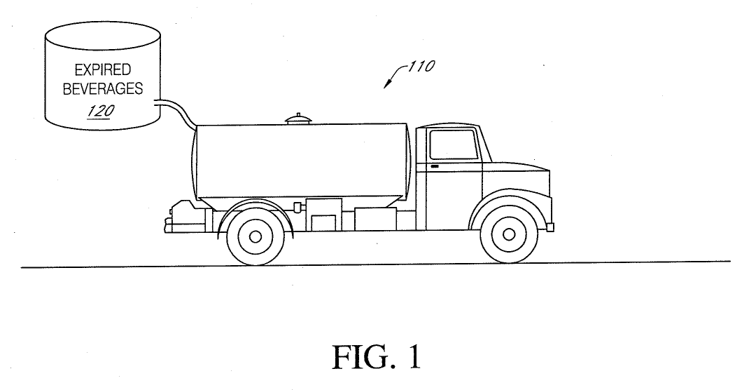

FIG. 1 illustrates a water truck, or other fluid delivery truck 110, receiving a quantity of expired beverages 120. The expired beverages 120 may be stored at a location controlled by a beverage supplier, such as a Coke® or Pepsi® facility. In other embodiments, the expired beverages 120 are stored at any other location, such as a location that is controlled by a third-party. In one embodiment, the expired beverages 120 comprise a mixture of soft drinks that have each passed their respective expiration dates. More particularly, the expired beverages 120 comprise a plurality of beverages having respective expiration dates of X (e.g., May 2005), wherein the current date is Y (e.g., August 2006), wherein Y is later in time then X. Thus, each of the expired beverages 210 has been determined to be unsuitable for human consumption by the beverage supplier and/or a regulatory agency, such as the U.S. Food and Drug Administration. In one embodiment, the expired beverages 120 are received from one or more retail businesses that sell beverages, wherein the beverages did not sell prior to their respective expiration dates and, therefore, have been returned to the beverage supplier for disposal. In other embodiments, the expired beverages 120 comprise one or more of any type of beverage, such as soft drinks, including carbonated and non-carbonated drinks, fruit juices, and alcoholic drinks. In one embodiment, the expired beverages 210 comprise one or more non-expired beverage, such as soft drinks that have not yet expired. Additionally, the systems and methods described herein may also be performed using non-expired beverages, rather than expired beverages. Thus, any reference herein to expired beverages should be interpreted to cover embodiments using a mixture of expired and non-expired beverages, as well as embodiments using only non-expired beverages.

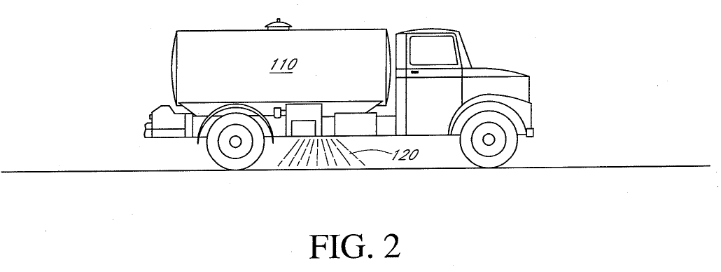

FIG. 2 illustrates the water truck 110 of FIG. 1 discharging the expired beverages 120 in order to suppress dust. The term “water truck,” as used herein, should be interpreted to cover any other apparatus that is suitable for dispensing a dust suppressant, such as a mixture of expired beverages. As noted above, the expired beverage mixture may be used as an expired beverage dust suppressant (referred to herein as an EBDS) by discharging the EBDS at any location at which suppression of dust is desired. In one embodiment, the EBDS comprises one or more additional substances that are added to the mixture of expired beverages, such as synthetic resins, asphaltic emulsions, polymer emulsions, and/or hygroscopic salt, for example. As used herein, the term “dirt” is defined to broadly encompass any material on which a dust suppressant may be applied, including, but not limited to, earthen materials including felsic igneous and metamorphic rocks, silicate rocks, such as granite and basalt, oxides, and other trace elements. In one embodiment, the expired beverages in the EBDS 120 are dewatered after application on dirt, or other surface, such that a layer of EBDS 120, for example, a semi-rigid shell of EBDS 120, is formed on the dirt. This shell formed from the dewatered EBDS advantageously reduces the amount of dust that is lifted from the dirt, such as may be caused by blowing wind. Depending on the specific dust suppression needs, multiple layers of EBDS may be discharged on to the dirt in order to increase a thickness of the shell that is formed and further decrease the amount of dust that may be lifted from the ground.

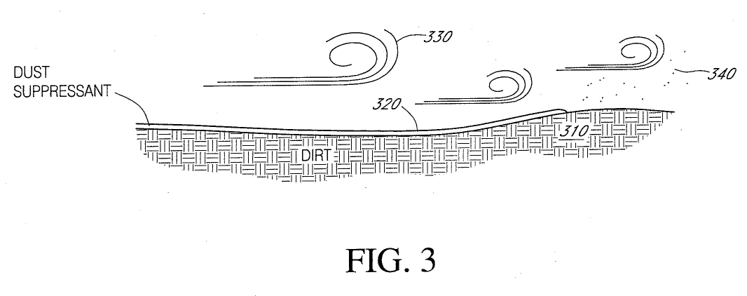

FIG. 3 is a cross sectional view of an uppermost layer of dirt 310, such as the topmost surfaces of dirt at a construction development site. In the embodiment of FIG. 3, the dirt 310 is partially covered by the discharged EBDS, where the expired beverages in the EBDS have been dewatered in order to form a crust or shell 320 on the dirt 310. When the EBDS 320 is initially discharged on to the dirt 310, the EBDS 320 is in a viscous form. However, as the viscous EBDS 320 settles and remains on the dirt 310 for a period of time, the beverages in the EBDS 320 are progressively dewatered, forming a crust or shell 320 on the dirt 310. In one embodiment, the viscous EBDS 320 mixes with dust, or other earthen particles, prior to dewatering of the beverages. Accordingly, in one embodiment the EBDS 320 that is hardened to form a shell comprises dust or earthen particulates.

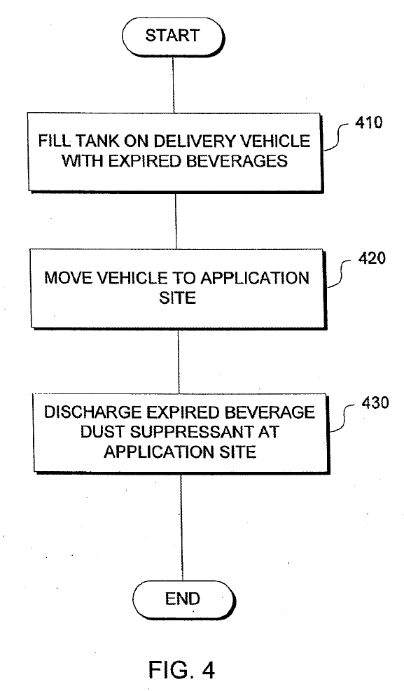

FIG. 4 is a flowchart illustrating an exemplary method of suppressing dust using an EBDS. Beginning in a block 410, a delivery vehicle, such as a water truck, is filled at least partially with a volume of expired beverages that may alone be used as an EBDS. In another embodiment, other substances may be added to the expired beverages to form the EBDS. In one embodiment, the expired beverages may include beverages of any type, including soft drinks, fruit juices, and alcoholic drinks. In one embodiment, the delivery vehicle comprises a water truck that has been modified to discharge EBDS. In another embodiment, the delivery vehicle comprises a spraying apparatus that is manually movable. Depending on the embodiment, certain of the blocks described below may be removed, others may be added, and the sequence of the blocks may be altered.

Moving to a block 420, the delivery vehicle is moved to a site where the EBDS is to be applied, which is referred to as an application site. In embodiments where the delivery vehicle comprises a water truck, the water truck may be driven to the application site. The application site may comprise any number of locations where application of EBDS is desirable and/or required. In an embodiment where the delivery vehicle is a manually movable apparatus, the apparatus may be loaded into a motor vehicle, for example, for delivery to the application site.

Continuing to a block 430, the EBDS in the delivery vehicle is discharged at the application site. In one embodiment, the water truck containing the EBDS is driven on the application site as the EBDS is discharged from the water truck, such that the EBDS is substantially evenly discharged on the application site. In one embodiment, multiple layers of EBDS are applied at the application site, such as by applying a second layer on top of a first layer, either before or after dewatering of the beverages in the first layer of EBDS.

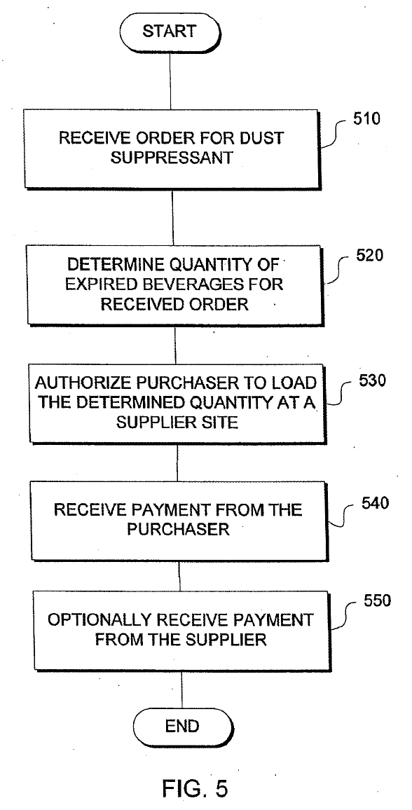

FIG. 5 is a flowchart illustrating an exemplary method of supplying EBDS to purchasers. Beginning in a block 510, a commercial entity, referred to herein as an “EBDS supplier,” receives an order for dust suppressant from a purchaser. For example, a purchaser may indicate a desired acreage or square footage that is to be covered by dust suppressant. Alternatively, the purchaser may indicate a volume of dust suppressant that is desired. Depending on the embodiment, certain of the blocks described below may be removed, others may be added, and the sequence of the blocks may be altered.

Moving to a block 520, a quantity of EBDS necessary for the received order is determined. As indicated above, in one embodiment the purchaser indicates to the EBDS supplier the volume of dust suppressant that is desired. In another embodiment, the commercial entity calculates a volume of EBDS that is necessary to adequately cover an acreage, square footage, or other area, indicated by the purchaser. In one embodiment, the amount of EBDS depends on a desired crust thickness. In another embodiment, the amount of EBDS depends on a composition of the surface on which the dust suppressant is to be applied.

Continuing to a block 530, the EBDS provider authorizes the purchaser to load the determined quantity of EBDS at a storage site, such as a site maintained by the supplier of expired beverages or a site that is maintained by the EBDS provider. For example, the supplier's site may comprise a warehouse housing one or more tanks that contain a mixture of expired beverages. In one embodiment, the supplier site is operated by a beverage manufacturer. In another embodiment, the supplier site is operated by a third-party.

Next, in a block 540, the EBDS provider receives payment from the purchaser for the determined quantity of EBDS. In one embodiment, payment is received prior to authorization to load the EBDS. In another embodiment, the purchaser is invoiced for the ordered EBDS according to accounting practices used by the EBDS provider.

In a block 550, the EDBS provider is compensated for disposal of expired beverages that are purchased by the purchaser. In one embodiment, the expired beverages are not suitable for human consumption and, thus, must be otherwise disposed. Accordingly, some beverage suppliers receive expired beverages back from their distributors and pay another entity for disposal of the expired beverages. Thus, the EDBS provider may coordinate the delivery of expired beverages to a purchaser, receiving payment for the expired beverages from the purchaser, and also receive payment for disposal of the expired beverages from the beverage supplier or other entity that is responsible for disposal of the expired beverages. In another embodiment, the beverage supplier does not pay the EDBS provider, but does provide the expired beverages at no charge to the EDBS provider.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of suppressing dust at a construction site comprising:
providing a vehicle equipped with a liquid holding tank and one or more liquid discharge devices;
filling at least a portion of the liquid holding tank with a mixture of expired soft drinks, the expired soft drinks being previously approved for human consumption, but at the time of performing the filling have passed respective expiration dates;
positioning the vehicle at an application site having an earthen surface; and
discharging portions of the mixture so that the mixture substantially covers a portion of the earthen surface, at least a portion of the mixture further mixing with dust on the earthen surface so as to retain the dust on the earthen surface and reduce an amount of dust that lifts from the earthen surface

2. The method of claim 1, wherein the mixture comprises one or more products manufactured by Pepsi® or Coke®.

3. The method of claim 1, wherein the vehicle comprises a water truck.

4. The method of claim 1, wherein the vehicle comprises a manually moveable apparatus.

5. The method of claim 1, further comprising dewatering the mixture such that a shell is formed on the earthen surface.

6. The method of claim 5, further comprising discharging an additional portion of the mixture on the shell.

7. A dust suppressant apparatus comprising:
a container holding a dust suppressant comprising a mixture of expired beverages, the expired beverages selected from the group comprising soft drinks, juices, and alcoholic drinks, wherein each of the expired beverages are associated with an expiration date that is earlier than a current date; and
a discharge apparatus configured to spray the mixture onto an earthen surface in order to reduce an amount of dust particles that are lifted from the earthen surface.

8. The dust suppressant apparatus of claim 7, wherein the dust suppressant further comprises one or more of: a polymer, a co-polymer, an acrylic polymer, an acrylic co-polymer, a polymer emulsion, a water-based polymer emulsion, a lignosulfonate, a surfactant, a resin, a synthetic resin, an acrylic resin, an emulsified resin, an enzyme, hydroseeding, hydroseeding mulch, hydromulch, hydromulch cellulose fiber, organic binder-hydroseeding, a chloride, gypsum, an asphaltic emulsion, a hygroscopic salt, a synthetic organic fluid, a brine solution, a soil conglomerate, a wood byproduct, an organic emulsion, an organic pulp, a seed mix, a wood pulp by-product, a soil additive, an enzyme formulation, a pine tar, a soybean product, an emulsified dust oil, an organic dispersion, and an organic enzymes.

9. The dust suppressant apparatus of claim 8, wherein the dust suppressant comprises at least about 90% expired beverages.

10. The dust suppressant apparatus of claim 8, wherein the dust suppressant comprises at least about 90% expired soft drinks.

11. The dust suppressant apparatus of claim 8, wherein the soft drinks comprise carbonated soft drinks.

12. A method of providing dust suppressant, the method comprising:
receiving an order from a purchaser for dust suppressant, wherein the dust suppressant comprises at least about fifty percent expired beverages;
authorizing a dust suppressant delivery vehicle to load the ordered quantity of dust suppressant at a facility that contains expired beverages; and
receiving payment from the purchaser for the ordered quantity of dust suppressant.

13. The method of claim 12, wherein the dust suppressant delivery vehicle comprises a water truck.

14. The method of claim 12, wherein the dust suppressant delivery vehicle is operated by the entity selling the dust suppressant.

15. The method of claim 12, wherein the dust suppressant delivery vehicle is operated by the purchaser.

16. The method of claim 12, further comprising:
receiving payment from a provider of the expired beverages for disposal of the expired beverages.
